(19) United States
(12) Patent Application Publication
(10) Pub. No.: US 2010/0034386 A1
(43) Pub. Date: Feb. 11, 2010

(54) DEVICE MANAGER REPOSITORY

(75) Inventors: Jason Yew Choo Choong, San Jose, CA (US); Zachary Brightlea Smith, San Francisco, CA (US); Dean Van Gerrevink, Glen Iris Victoria (AU); William Raymond Wood, South Yarra Victoria (AU)

Correspondence Address: FISH & RICHARDSON P.C., P.O BOX 1022, Minneapolis, MN, 55440-1022, US

(73) Assignee: Daintree Networks, Pty. Ltd., Scoresby (AU)

(21) Appl. No.: 12/187,194

(22) Filed: Aug. 6, 2008

(51) Int. Cl. H04L 9/00

(52) U.S. Cl. 380/270

(57) ABSTRACT

Apparatus, systems and methods for managing wireless devices. A wireless device identifier from an access device is received. An encryption key associated with the wireless device identifier that matches an encryption key stored in the wireless device is identified. The identified encryption key is transmitted to the access device so that the access device can communicate with the wireless device over an encrypted communication channel that is established by use of the identified encryption key and the encryption key stored in the wireless device.

### BACKGROUND

This disclosure relates to the management of wireless embedded network devices.

Wireless networks are typically configured according to wireless protocols. One type of wireless protocol is specified by the IEEE 802.15.4 standard, a standard to which low-rate wireless personal area networks (LR-WPANs) often conform. The ZigBee specification, published by the ZigBee Alliance, is based on the IEEE 802.15.4 standard. The ZigBee specification defines a suite of high level communication protocols that use low-power and low-bandwidth digital radios. The low power consumption and low bandwidth requirements of a ZigBee device reduces cost and prolongs battery life, and thus such devices are often used for sensors, monitors and controls.

The basic components in a ZigBee network are a ZigBee coordinator (ZC), and ZigBee router (ZR), and a ZigBee end device (ZED). The ZigBee coordinator, of which there is only one in a ZigBee network, is responsible for initial configuration and continuing control of the network, and the ZigBee router relays and responds to messages in the network. The ZigBee end devices can send messages to and receive messages from the ZigBee router. Because the ZigBee end devices are well suited for monitoring and control, a ZigBee network can be used to implement energy demand management programs for a residential or commercial property. These programs, often known as “Automatic Metering Infrastructure” (AMI) or “smart metering”, often place a ZigBee coordinator in an electric meter to facilitate energy management by a service provider, e.g., a utility company. For example, electrical, gas and water meters can be read in real time, and corresponding control devices, such as thermostats and light switches, can be controlled by the service provider to provide energy savings.

As part of a device discovery process, the current ZigBee speciation allows for the ZigBee end devices to receive a network key. This network key can then be used by the ZigBee end device to establish an encrypted channel. The network key can be transmitted to the ZigBee end device in the clear. However, transmitting the network key in the clear imposes a significant security risk; if the network key is received by a malicious user, the entire ZigBee network can be compromised.

To alleviate this problem, each device can be pre-configured with a corresponding device key. The device key can be input by an administrator to, for example, the ZigBee coordinator, or some other ZigBee device that maintains a trust center. Once received by the ZigBee coordinator, the coordinator can establish a secure tunnel to the joining device using the device key and transmit the network key to the joining device over the secure tunnel. After receiving the encrypted network key, the joining device can decrypt the encrypted network key and join the encrypted network.

When installing wireless networks, however, enabling security and/or functionality features of the devices can be time consuming and prone to error. For example, a network administrator, using a software configuration tool, is required to enter the key for each device that is to join the network. However, as there are often dozens, and perhaps hundreds of ZigBee devices per network, this process is time consuming and prone to error.

Additionally, once the ZigBee devices are joined to the network, each ZigBee device must provide device data, e.g., cluster attribute data, binding data, and other device data that defines the device functionalities to the ZigBee coordinator. With potentially hundreds of devices being joined or on the low-bandwidth network, temporary degradation of the network traffic capabilities can occur.

### SUMMARY

In general, one aspect of the subject matter described in this specification can be embodied in methods that include the actions of receiving a wireless device identifier from an access device, the wireless device identifier identifying a wireless device in communication with the access device; identifying an encryption key associated with the wireless device identifier, the identified encryption key matching an encryption key stored in the wireless device; and transmitting the identified encryption key to the access device so that the access device can communicate with the wireless device over an encrypted communication channel that is established by use of the identified encryption key and the encryption key stored in the wireless device. Other embodiments of this aspect include corresponding systems, apparatus, and computer program products.

Another aspect of the subject matter described in this specification can be embodied in methods that include the actions of receiving a wireless device identifier from an access device, the wireless device identifier identifying a wireless device in wireless communication with the access device, the access device being connected to a network and facilitating a wireless connection of the wireless device to the network; identifying a wireless device identifier in a data store that matches the received wireless identifier; identifying device functional data, such as a corresponding cluster data set, stored in the data store and associated with the identified wireless device identifier; and transmitting the corresponding cluster data to a service provider that provides a service to a user of the wireless device by use of the wireless device. In some implementations, the cluster data can be transmitted to the service provider by the access device. In other implementations, the cluster data can be transmitted to the service provider by a repository manager that manages the data store. Other embodiments of this aspect include corresponding systems, apparatus, and computer program products.

Various optional advantages can be realized by use of the systems and methods described herein. The systems and methods herein can be implemented in a flexible software solution in a router or coordinator, capable of being deployed on a standalone device, or integrated into another device such as a smart meter, set-top box or broadband modem/router. A corresponding repository manager and data repository can be implemented by a third party, or separately implemented for each device manufacturer. In conjunction with standardized hardware that handles the low-level networking, the systems and methods herein provide Original Equipment Manufacturers (OEMs) the capability to rapidly and economically create WPANs, such as energy management systems in residential or commercial buildings, in a manner that minimizes security risks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a device manager repository can be used for network management.

FIG. 2A is a block diagram of an example wireless device.

FIG. 2B is a block diagram of an example access device with which the wireless device communicates.

FIG. 3 is a flow chart of an example process for establishing service of a wireless device.

FIG. 4 is a flow chart of an example process for establishing an encrypted communication channel with a wireless device by use of a device manager repository.

FIG. 5 is a flow chart of an example process for establishing service of a wireless device.

FIG. 6 is a flow chart of an example process for populating a device manager repository with wireless device data.

Like reference numbers and designations in the various drawings indicate like elements.

### DETAILED DESCRIPTION

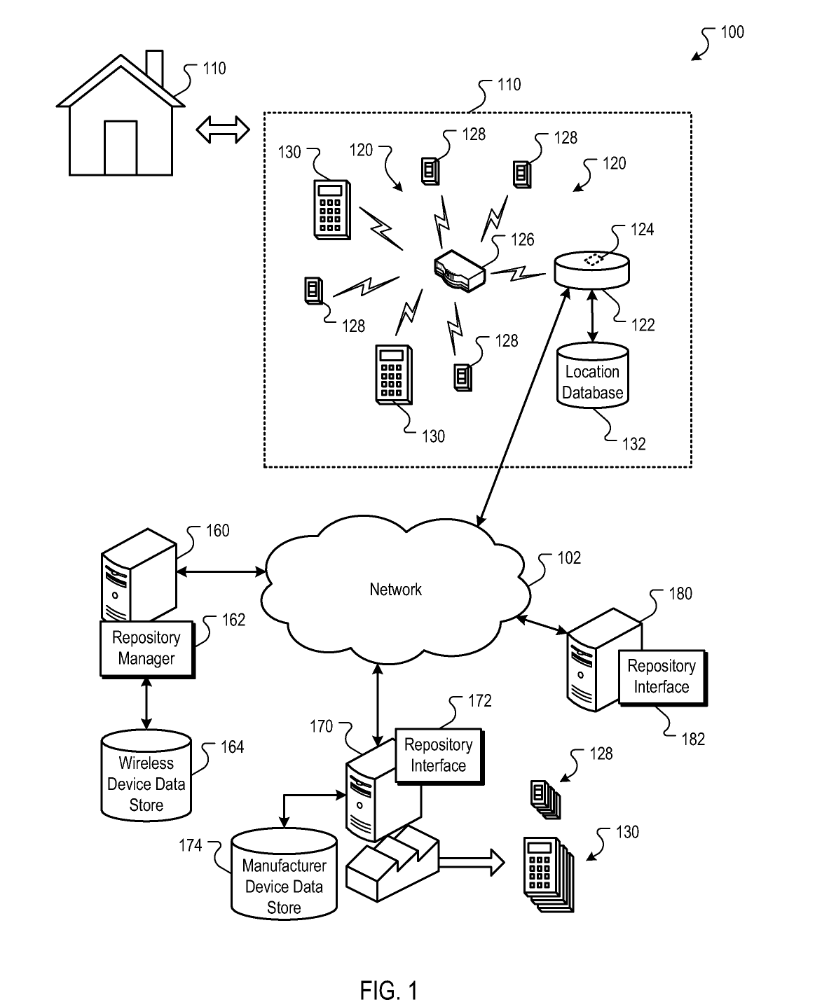

FIG. 1 is a block diagram of an example environment 100 in which a device manager repository 162 can be used for network management. A computer network 102, such as wide area network (WAN), e.g., the Internet, connects a first wireless network 120 located in a building 110 to a wireless device repository 160. The network 102 also connects a wireless device manufacturer 170 and a service provider 180 to the wireless device repository 160.

The first wireless network 120 can, for example, be a wireless personal area network (WPAN), such as a ZigBee network based on the IEEE 802.15.4 protocol. The first wireless network 120 can be implemented using a ZigBee coordinator 122, one or more ZigBee routers 126, and a plurality of ZigBee end devices 128 and 130 (to avoid drawing congestion, only one ZigBee router 126 is shown). The ZigBee coordinator 122 is responsible for initial configuration and continuing control of the network 120, and the ZigBee router 126 relays messages on behalf of other devices in the network 120. The ZigBee end devices 128 and 130 can send messages to and receive messages from other ZigBee devices such as the coordinator 122, router 126 or other end devices 128 and 130, but unlike a ZigBee router 126 they cannot relay messages on behalf of other devices.

The ZigBee end devices 128 and 130 are low power devices that conform to the physical (PHY) and media access control (MAC) layers of the IEEE 802.15.4 protocol, and can thus operate for extended periods, e.g., months or even years, on batteries. Thus, the devices 128 and 130 are well suited for monitoring and control in a building, such as a residential or commercial property. The functionality of each device 128 and 130 can vary. In the example network 120 of FIG. 1, devices 128 are switches and devices 130 are thermostats. The functionality of the devices 128 and 130 is defined by cluster data stored in each device. The cluster data generally conforms to a ZigBee cluster library, which defines functional domains (e.g., security, HVAC, etc.) and provides a set of cluster data for each device. This cluster data defines for each device mandatory attributes and possibly optional attributes, cluster specific commands, functional descriptions, and internal logic and tables. Example cluster data can include the ZigBee cluster library version, an application version, a stack version, a hardware version, a manufacturer name, a model identifier, and a date code.

In addition to cluster data, the devices 128 and 130 can also include binding data, such as a biding table. The binding table defines point-to-point logical links between inputs and outputs defined by the cluster data. The bindings defined by the binding tables are used to establish application level-connections between two devices according to their complementary functions. Thus, a binding is made on a cluster that defines the functions of the ZigBee device.

The ZigBee router 126 can also be used to realize controller functionality. For example, the ZigBee router 126 can be an HVAC controller, and include binding and cluster data to control some of the end devices 128 and 130. Often the device that implements router functionality is a device that is connected to a power main, e.g., a power outlet, as its power requirements are greater than an end device.

The cluster data and binding data are typically loaded onto the device by the device manufacturer, such as the manufacture 170. When a device 128 or 130 is joined to the network 120, the ZigBee coordinator 122 receives the cluster data associated with the device and can establish control of the device.

One example use of the network 120 can be the implementation of energy demand management programs for a residential or commercial property. Illustrated in FIG. 1 is an “Automatic Metering Infrastructure” (AMI) or “smart metering” service that is facilitated by placing the ZigBee coordinator 122 in an electric meter to facilitate energy management by a service provider 180, e.g., one or more utility companies. For example, electrical, gas and water meters can be read in real time, and the corresponding control devices 128 (e.g., switches) and 130 (thermostats), can be controlled by the service provider 180 to provide utility savings.

When installing or managing the wireless network 120, enabling security and/or functionality features of the devices are facilitated by a device manager 124, a wireless device data repository 160, and repository interfaces 172 and 182. In some implementations, the device manager 124 is a software application that is implemented in a trust center, i.e., a functionality that is implemented, usually in the coordinator 122, that allows wireless devices 126, 128 and 130 (i.e., any device capable of wireless communication) to join the network and distribute a network key to the joining device. In other implementations, the device manager 124 can be implemented separately from the trust center.

Use of the device manager 124, the wireless device data repository 160, and repository interfaces 172 and 182 facilitates the efficient establishment of secured wireless communication channels with little user intervention and without the transmission of any security data in unencrypted form, i.e., “in the clear.” Additionally, for networks that require additional device functional data, such as cluster data and binding data, for example, use of the device manager 124, the wireless device data repository 160, and repository interfaces 172 and 182 facilitates the delivery of such data to the ZigBee coordinator 122 and/or service provider 180 without intruding on the relatively low bandwidth of network 120.

In some implementations, these features can be achieved by storing an association of wireless device identifiers and encryption keys that are loaded onto the wireless devices 126, 128 and 130 before installation, such as during device manufacture or during a configuration process that occurs before installation. In some implementations, the wireless device identifiers for the wireless devices can be a MAC address of the wireless device. Other quasi-unique or unique identifiers can also be used.

When a wireless device 126, 128 or 130 attempts to join a network, the wireless device will typically provide an identifier in the clear, e.g., a MAC address of the network interface card transmitted in unencrypted form, for example. An access device, such as the coordinator 122, receives the broadcast wireless identifier either directly from the wireless device or via the router 126, and can attempt to establish communication with the wireless device.

In some implementations, the wireless devices have pre-loaded security keys, and an association of the security keys and wireless device identifiers are stored in a data store. As the access device does not have the pre-loaded security key of the wireless device, the access device cannot establish a secure communication with the wireless device upon receiving the device's MAC address. Thus, the security keys are accessible to the access device by use of the wireless device repository 160 running a repository manager 162 and having access to a wireless device data store 164. The wireless device data store 164 stores associations of first encryption keys to wireless device identifiers. Each wireless device identifiers identifies a corresponding wireless device, such as one of the devices 122, 126 or 128, storing a corresponding second encryption key. Each first encryption key corresponding to a wireless device identifier is matched to the second encryption key stored in the wireless device identified by the wireless device identifier. If the first and second encryption keys are symmetric keys, then the first and second encryption keys are the same keys. Alternatively, if the first and second encryption keys are public and private key pairs, then one of the keys, e.g., the first key, is a public key, and the other key, e.g., the second key, is a private key.

Upon receiving the wireless device identifier, the device manager 124 operating in the coordinator 122 transmits the wireless device identifier to the wireless device repository 160 as part of a device data request. The repository manager 162, in response to receiving the wireless device identifier, searches the data store 164 to determine if the received wireless device identifier matches a stored wireless device identifier. If there is a match, then a first encryption key associated with the received wireless device identifier is identified. The repository manager 162 then transmits the identified encryption key to the device manager 124 on the coordinator 122. In response to receiving the encryption key, the coordinator 122 can establish a first encrypted communication channel with the corresponding wireless device by use of the received first encryption key and the second encryption key that stored in the wireless device.

Thereafter, if the network 120 has a network key that is used to establish the same secured channels for all devices on the network, the device manager 124 can provide the network key to the wireless device over the first secured communication channel established by use of the wireless device repository 160.

In some implementations, communication with the repository manager 162 can likewise be protected by at least an authorization process, and optionally by an additional layer of security. An example authorization process can include a user name and password that is input by a user; or an account verification process that occurs automatically and that verifies that the access device, e.g., coordinator 122, is subject to a license agreement for access to the wireless device repository. Such a license agreement can be purchased by an end user, or can be purchased by the manufacturer of the access device, e.g., the coordinator 122. Such access devices that do not include a device manager or that are not subject to such an access license can be precluded from receiving wireless device data stored in the data store 164. In these situations, the wireless device data can be manually input by the user or transmitted in the clear.

An example additional security layer can be a public key-private key pair exchange and an encrypted transport mechanism, such as a secured sockets layer (SSL) or secured shell (SSH). The additional security layer allows communications between the access device and the repository manager 162 to be further secured when transmitting over the network 102. Other additional encryption schemes can also be used.

In some implementations, the data store 164 further stores device functional data that defines one or more device functionalities. For example, if the wireless devices 126, 128 and 130 are ZigBee devices, the data store 164 can store cluster attribute data and binding data associated with each wireless device identifier and which defines one or more wireless device functionalities and bindings, such as lighting functions and bindings, HVAC functions and bindings, or metering functions and bindings, to name just a few. The repository manger 162 can identify the cluster data and binding data associated with the wireless device identifier and transmit the cluster data to the coordinator 122. Accordingly, each device 126, 128 and 130 need not provide its corresponding cluster data over the network 120, thereby conserving network bandwidth.

In some implementations, the device functional data can also be provided separately to the service provider 180 that provides a service to a user of the wireless devices, e.g., energy management. In these implementations, the repository manager 162 can communicate with a repository interface 182 located at the service provider 180. An example repository interface 182 can be server-based application or applet that is configure to receive data from the repository manger 162 and the device manager 124, and also to transmit data to the repository manager 162 and device manager 124.

As the service provider 180 may provide services to many entities, the number of devices used in such networks 120 can be in millions. Accordingly, in some implementations, by receiving the device function data from the repository manager 162 over an Internet backbone, bandwidth requirements for the link between the coordinator 122 and the network 102 can be reduced.

Population of the wireless device data store 164 can be accomplished in several ways. In one implementation, the device manufacture 170, by use of a repository interface 172, can pre-load encryption keys onto the wireless devices 126, 128 and 130, and can store associations of the encryption keys and wireless device identifiers in the manufacturer device data store 174. An example repository interface 172 can be server-based application or applet that is configured to receive data from the repository manger 162, and also to transmit data to the repository manager 162.

Additionally, if the devices include device functional data, such as the binding data and cluster data, the device functional data can also be associated with corresponding wireless device identifiers and stored in the in the manufacturer device data store 174. The manufacture 170 can have an account associated with the wireless device repository 160, and can also have associated write privileges to the data store wireless device data store 164. By logging into the repository manager 162, the manufacturer can provide the device data stored in the manufacturer device data store 174 to the wireless device data store 164. By doing so, the manufacture 170 ensures that access to the devices 126, 128 and 130, and any associated device functional data, can be easily and securely established by end users of its wireless devices.

In some implementations, partner accounts can be associated with a device manufacturer account. Example partner accounts can include manufactures of the coordinator 122 and/or the wireless devices 126, 128 and 130, or companies that are authored installers of equipment manufactured by the manufacturer. In some implementations, the users of the partner account can read only the device data associated with the device manufacture that is partnered with the partner account. Optionally, users of the partner account can be granted write access to the data store 164 to upload device data and/or modify device data stored in the data store 164. For example, an installer of the network 120, which can be the service provider 180 or another party, can configure (or reconfigure) the wireless devices 126, 128 and 130, thereby providing or modifying the device data. These changes can then be provided to the device data store 164.

In some implementations, the coordinator 122 can maintain a location database 132 that caches the cluster data and binding data of the devices 126, 128 and 130. This allows requests from the service provider 180, or other energy management providers, to be serviced directly by the coordinator 122 without intruding on the low bandwidth wireless network 120.

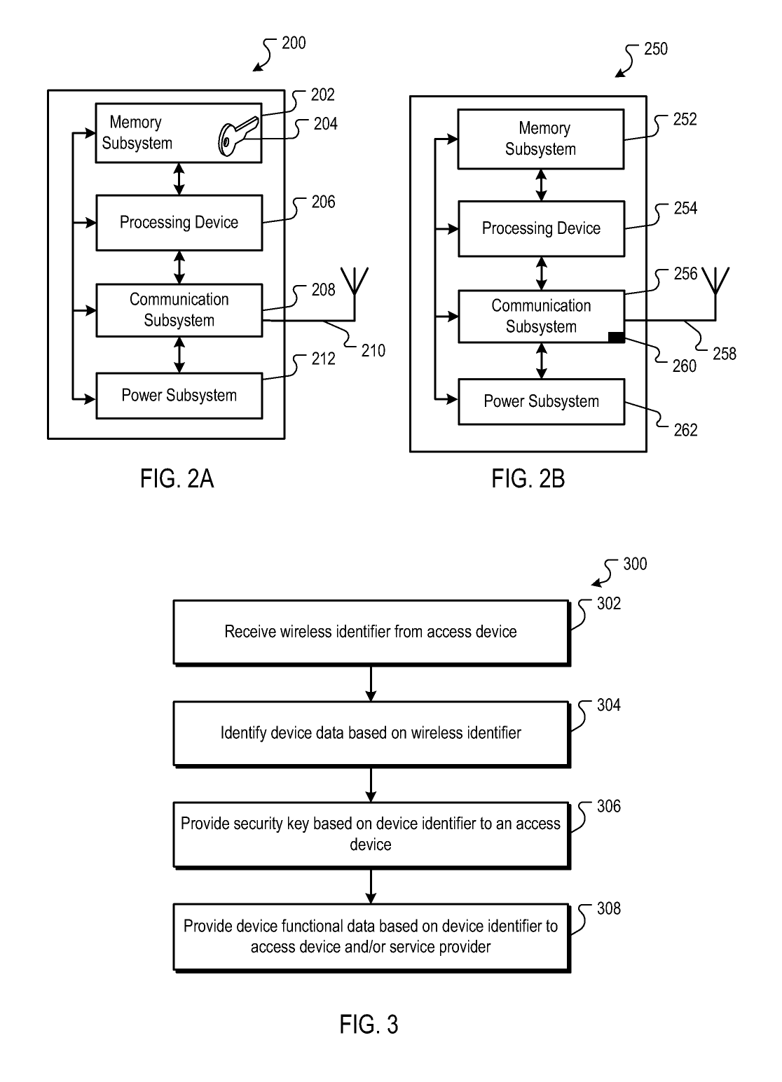

FIG. 2A is a block diagram of an example wireless device 200 that can be used to implement the devices 126, 128 and 130. The wireless device 200 includes a memory subsystem 202, a processing device 206, a communication subsystem 208, and a power subsystem 212. The memory subsystem 202 can store instructions executable by the processing device 206 and that upon such execution cause the processing device 206 to perform operations defined by the instructions. The memory subsystem 202 also stores an encryption key 204 that can be stored in the memory subsystem at manufacturing time or at a later time, such as during a subsequent configuration process by the manufacturer 170 or some other entity. In some implementations, the memory subsystem 202 can also include device functional data, such as cluster data for a ZigBee end device. Other device functional data can also be stored in the memory subsystem, depending on the device 200 type and the associated protocol to which the device conforms.

The communication subsystem 210 can include a radio frequency transceiver that transmits and receives data by use of an antenna 210, and media access control circuitry and associated software or firmware. In some implementations, the communication subsystem can implement the data link layer and physical layer according or the IEEE 802.15.4 protocol. Other communication protocols, however, can also be used. Each wireless device 200 has an associated identifier, such as a MAC address, that is typically also be stored in the memory subsystem 202.

The power subsystem 212 can, for example, include circuitry to provide regulated power from a battery and/or from a wired power source. The power subsystem 212 can optionally include circuitry that connects to a power grid, such as a power outlet or power main. Such powered connections are used in wireless devices that route network traffic, such as the device 126.

FIG. 2B is a block diagram of an example access device 250 with which the wireless device 200 communicates. The access device 250 can be used to implement the coordinator 122.

The access device 250 includes a memory subsystem 252, a processing device 254, a communication subsystem 256, and a power subsystem 262. The memory subsystem 252 can store instructions executable by the processing device 254 and that upon such execution cause the processing device 254 to perform operations defined by the instructions. The instructions can, for example, include software that is used to implement the device manager 124.

The communication subsystem 256 can include a radio frequency transceiver that transmits and receives data by use of an antenna 258, and can also include a wired transceiver that can communicate over a wired connection 260, such as an Ethernet link, or other communication protocol. The communication subsystem 260 also includes media access control circuitry and associated software or firmware. In some implementations, the communication subsystem can implement the data link layer and physical layer according to the IEEE 802.15.4 protocol. Other communication protocols can also be used.

The power subsystem 262 can, for example, include circuitry that connects to a power grid, such as a power outlet or power main. Optional power circuitry can also provide regulated power from a battery and/or from a wired power source.

FIG. 3 is a flow chart of an example process 300 for establishing service of a wireless device. The process 300 can, for example, be implemented in the repository manger 162 of FIG. 1.

A wireless device identifier is received from an access device (302). For example, the repository manager 302 can receive a wireless device identifier, such as a MAC address, from an access device, such as the coordinator 122.

Device data based on the wireless identifier is identified (304). For example, the repository manager 162 can identify device data such as a security key and device functional data associated with a wireless device identified by the wireless device identifier.

The security key is provided to the wireless access device (306). For example, the repository manager 302 can transmit the security key to the coordinator 122. The security key can be a pre-loaded key on the wireless device, and can be used to establish an encrypted communication with the wireless device.

The device functional data based on the device identifier is provided to the access device and/or service provider (308). For example, the repository manager 302 can transmit the device functional data to the coordinator 122, and can also transmit the device functional data to the service provider 180.

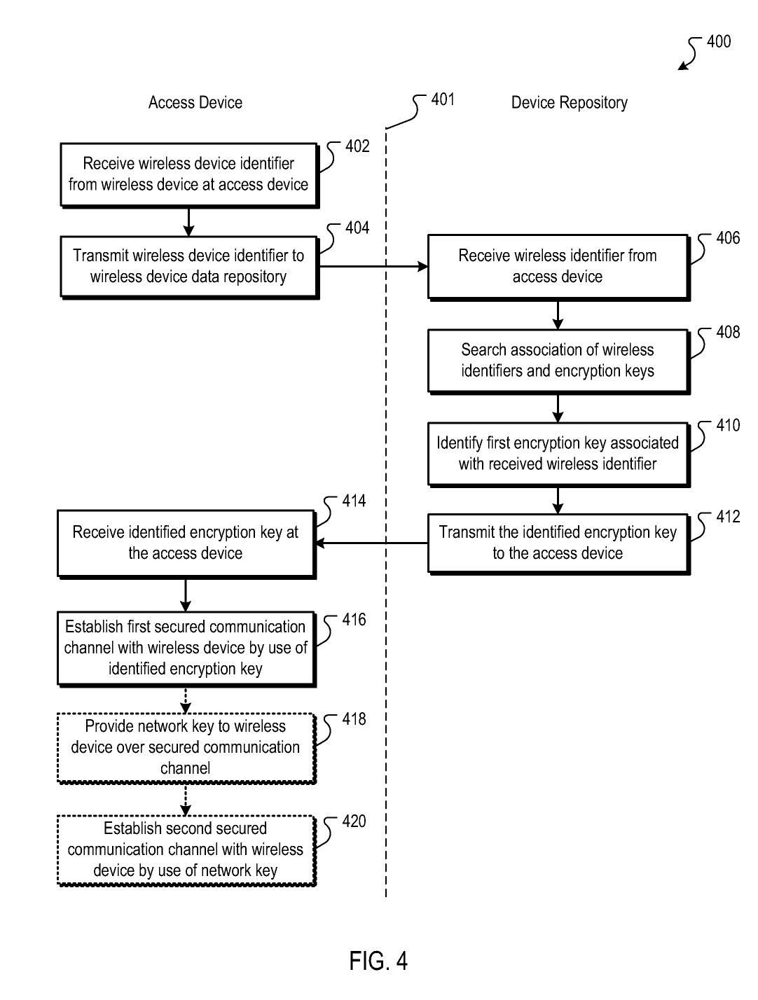

FIG. 4 is a flow chart of an example process 400 for establishing an encrypted communication channel with a wireless device by use of a device manager repository. The process 400 can be implemented in the coordinator 122 use of the device manager 124, and the repository manager 162 of FIG. 1, and as indicated by the process partition line 401.

A wireless device identifier is received from a wireless device at an access device (402). For example, the device manager 124 on the coordinator 122 can receive the MAC addresses of the ZigBee end devices 128 and 130, or the router 126.

The wireless device identifier is transmitted to the wireless device data repository (404). For example, the coordinator 122, running respective device manager 124, can transmit the wireless device identifier to the repository manager 162.

The wireless device identifier is received from the access device at the wireless device data repository (406). For example, repository manager 162 can receive the wireless device identifier from the coordinator 122.

An association of wireless identifiers and encryption keys are searched using the received wireless identifier (408). For example, the repository manager 162 can search the wireless device data store 164 using the received wireless device identifier.

A first encryption key associated with the received wireless identifier is identified (410). For example, the repository manager 162 can identify a matching wireless device identifier in the data store 164, and thereby identify a first encryption key associated with the received wireless device identifier.

The identified encryption key is transmitted to the access device (412). For example, the repository manager 162 can transmit the identified encryption key to the coordinator 122. In some implementations, the encryption key can also be transmitted with the correspond wireless device identifier as a identifier-key pair if the device manager does not associate received keys with prior transmitted key requests, such as in the case of the device managers being stateless managers.

The access device receives the identified encryption key (414). For example, the coordinator 122 can receive the encryption key for the wireless device that provided a MAC address.

A first secured communication channel is established with the wireless device by use of the identified encryption key (416). For example, the coordinator 122 can encrypt communications to the device using the encryption key provided by the repository manager 162 in response to the request for the security key.

Optionally, a network key is provided to the wireless device over the secured communication channel (418). For example, the coordinator 122 can provide a network key that is used to secure all communications over a network. The network key is provided using the communication channel established with the key provided from the repository manager 162.

A second secured communication channel is established with the wireless device by use of the network key (420). For example, the coordinator 122, or the wireless devices 126, 128, or 130 can begin transmitting data over a second secured channel by use of the network key.

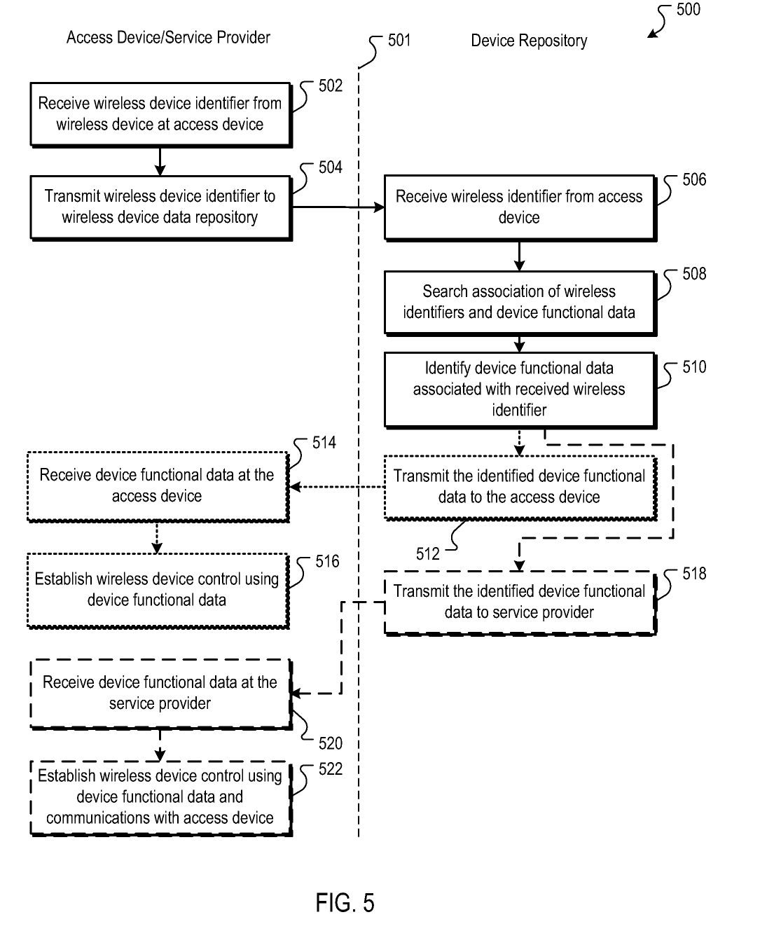

FIG. 5 is a flow chart of an example process 500 for establishing service of a wireless device. The process 500 can be implemented in the coordinator 122 by use of the device manager 124, the repository manager 162, and the service provider 170 by use of the repository interface 172 of FIG. 1, and as indicated by the process partition line 501.

A wireless device identifier is received from a wireless device at an access device (502). For example, the device manager 124 on the coordinator 122 can receive the MAC addresses of the ZigBee end devices 128 and 130, or the router 126.

The wireless device identifier is transmitted to the wireless device data repository (504). For example, the coordinator 122, running the device manager 124, can transmit the wireless device identifier to the repository manager 162.

The wireless device identifier is received from the access device at the wireless device data repository (506). For example, the repository manager 162 can receive the wireless device identifier from the coordinator 122.

An association of wireless identifiers and device functional data is searched using the received wireless identifier (508). For example, the repository manager 162 can search the wireless device data store 164 using the received wireless device identifier.

Device functional data associated with the received wireless identifier is identified (510). For example, the repository manager 162 can identify a matching wireless device identifier in the data store 164, and thereby identify device functional data, e.g., cluster data and/or binding data, with the received wireless device identifier.

In some implementations, the identified device functional data is transmitted to the access device (512). For example, the repository manager 162 can transmit the identified device functional data to the coordinator 122. In some implementations, the device functional data can also be transmitted with the correspond wireless device identifier as a identifier-functional data pair if the device manager does not associate received device functional data with prior transmitted device functional data requests, such as in the case of the device managers being stateless managers.

The access device receives the identified device functional data (514). For example, the coordinator 122 can receive the device functional data for the wireless device that provided a MAC address, and can store the device functional data in the location database 132.

The access device establishes control of the wireless device using the device functional data (514). For example, the coordinator 122 can establish control of the wireless device by use of the cluster data provided from the repository manager 162.

In some implementations, the identified device functional data is transmitted to a service provider (518). For example, the repository manager 162 can transmit the identified device functional data to service provider 180. In some implementations, the device functional data can also be transmitted with the corresponding wireless device identifier.

The service provider receives the identified device functional data (520). For example the repository interface 182 can receive the device functional data from the repository manager.

The service provider establishes control of the wireless device using the device functional data (522). For example, the service provider 180 can establish control of the wireless device by use of the cluster data provided from the repository manager, and by communications with the coordinator 122. Such control can be used to provide services, such as utility management.

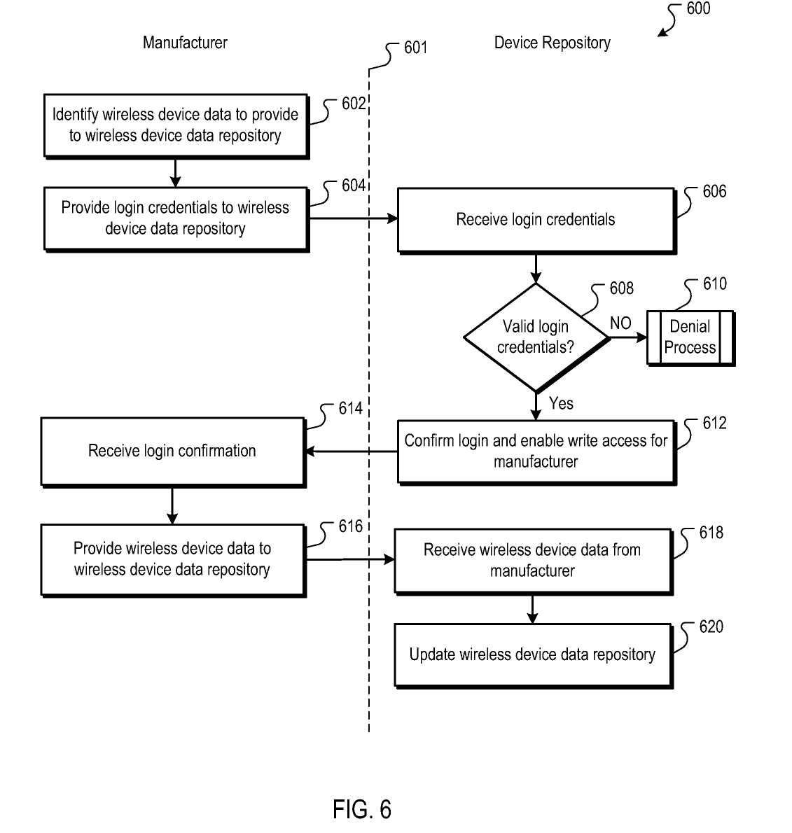

FIG. 6 is a flow chart of an example process 600 for populating a device manager repository with wireless device data. The process 500 can be implemented in the device in the repository manager 162 and the service provider by use of the repository interface 172 of FIG. 1, and as indicated by the process partition line 601.

Wireless device data to provide to the wireless device data repository is identified (602). For example, a manufacturer 170 can identify a MAC address (or other quasi-unique or unique device identifier), an encryption key, and optional device functional data of the devices that it manufactures.

Login credentials are provided to the wireless device data repository (604). For example, the manufacture 170 can provide login credentials to the repository manager 162 by use of the repository interface 172 and a secured channel, e.g., by using an SSL or SSH secured communication.

The login credentials are received at the wireless device data repository (606). For example, the repository manager 162 can receive the login credentials from the manufacturer 170.

The login credentials are processed to determine whether the credentials are valid (608). For example, the repository manager 162 can determine whether the credentials are valid credentials.

If the credentials are not valid, a denial process is instantiated (610). For example, the repository manger 162 can notify the manufacturer 170 that the login credentials provided are invalid.

If the credentials are valid, then the login is confirmed and write access for the manufacture is enabled (612). For example, the repository manger 162 can enable write access for the manufacture 170 and provide the login confirmation to the manufacturer 170.

The login confirmation is received by the manufacturer (614). For example, the repository interface 172 can receive the login confirmation from repository manger 164.

The wireless device data is provided to the wireless device data repository (616). For example, the repository interface 174 can access the manufacturer device data store 174 and provide wireless device identifiers and corresponding encryption keys for the devices 126, 128 and 130, and optionally provide the device functional data for devices 126, 128 and 130.

The wireless device data is received from the manufacturer (618). For example, the repository manager 162 can receive the device data from the manufacture 170.

The device data repository is updated using the received wireless device data (620). For example, the wireless device data store 164 can be updated to include wireless device identifiers and corresponding encryption keys for the devices 126, 128 and 130, and optionally provide the device functional data for devices 126, 128 and 130.

Other variations in the systems and processes described above can be used. For example, a block of devices can all have the same encryption key, e.g., devices can be provided the same encryption key for a manufacture; or a manufacture may be provided a set of encryption keys from the repository manager 162 and the encryptions keys can be randomly assigned. Management and maintenance of any wireless network that can use encryption keys and/or device functional data can be facilitated by use of a wireless device data repository 160.

In additional, additional device data can also be stored in the data store 164, including the device type and manufacturer. For ZigBee devices in particular, in addition to the cluster data and binding data, additional data such as the power descriptor, node descriptor, and start attribute set can also be stored and provided to either the coordinator 122 or the service provider 180.

The device type data can include a device type identifier, a manufacturer code, a model, and EAN/UPC product code, and an application version. The manufacturer data can include the manufacturer code and the manufacturer name.

The node descriptor data can include a logical type, an application support sublayer (APS) flag, MAC capability flags, a buffer size, a maximum incoming transfer size, a server mask, a maximum outgoing transfer size, and a descriptor capability field.

Although the systems and methods herein have been illustrated in the context of the IEEE 802.15.4 protocol and the ZigBee specification, the systems and methods herein are not limited to the example implementations above. The systems and methods herein can be used with any protocol that facilitates the distribution of security keys and/or device functional data as described herein.

Furthermore, other applications and services besides energy management can be supported by the systems and methods described herein. For example, health monitoring services, security services, or any other service that makes use of wireless devices can also be supported.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The computer readable medium can be a machine readable storage device, a machine readable storage substrate, a memory device, a composition of matter effecting a machine readable propagated signal, or a combination of one or more of them. For example, software stored on a computer readable medium and comprising instructions that cause a processing device to perform operations can be used to implement the device manager 124, the repository manger 162, and the repository interfaces 172 and 182.

The processing devices disclosed herein encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system, comprising:
a data store storing associations of first encryption keys to wireless device identifiers, each association defining an association of a first encryption key to a wireless device identifier, the wireless device identifier identifying a corresponding wireless device storing a corresponding second encryption key, and the first encryption key being matched to the second encryption key;
a repository manager comprising instructions executable by a processing system that includes one or more computers and upon such execution cause the processing system to perform operations comprising:
receiving a wireless device identifier from an access device, the wireless device identifier identifying a wireless device in communication with the access device, the access device being connected to a network and facilitating a wireless connection of the wireless device to the network;
identifying a wireless device identifier in the data store that matches the received wireless device identifier;
identifying a first encryption key associated with the identified wireless device identifier; and
transmitting the identified encryption key to the access device so that the access device can communicate with the wireless device over an encrypted communication channel that is established by use of the identified first encryption key and the second encryption key stored in the wireless device.

2. The system of claim 1, wherein the first and second matched encryption keys are symmetric encryption keys.

3. The system of claim 1, wherein the wireless device identifier is received by the access device over an unencrypted communication.

4. The system of claim 1, wherein the wireless devices communicate according to an IEEE 802.15.4 standard.

5. The system of claim 1, wherein:
the data store further stores device functional data associated with each wireless device identifier, the device functional data defining one or more wireless device functionalities; and
the repository manager comprises further instructions executable by the processing system and upon such execution cause the processing system to perform operations comprising:
identifying the device functional data associated with the identified wireless device identifier; and
transmitting the device functional data to a service provider that provides a service to a user of the wireless device by use of the wireless device.

6. The system of claim 5, wherein the repository manager comprises further instructions executable by the processing system and upon such execution cause the processing system to perform operations comprising transmitting the device functional data to the access device.

7. The system of claim 6, wherein:
the wireless devices communicate according to an IEEE 802.15.4 standard;
the access device is a ZigBee coordinator device; and
the device functional data comprises cluster data.

8. The system of claim 5, wherein the service provider is a energy management provider, and the service is energy management.

9. The system of claim 5, wherein the repository manager comprises further instructions executable by the processing system and upon such execution cause the processing system to perform operations comprising associating write privileges for the data store with a device manufacturer account, the device manufacturer account being associated with a device manufacturer of the wireless devices.

10. The system of claim 9, wherein the repository manager comprises further instructions executable by the processing system and upon such execution cause the processing system to perform operations comprising:
receiving associations of wireless identifiers and first encryption keys from the device manufacture; and
storing the associations of the wireless identifiers and first encryption keys in the data store according to the write privileges.

11. The system of claim 9, wherein the repository manager comprises further instructions executable by the processing system and upon such execution cause the processing system to perform operations comprising:
receiving associations of wireless identifiers and device functional data from the device manufacture; and
storing the associations of wireless identifiers and the device functional data in the data store according to the write privileges.

12. The system of claim 10, wherein the repository manager comprises further instructions executable by the processing system and upon such execution cause the processing system to perform operations comprising:
associating partner accounts with a device manufacturer account;
associating read privileges for the data store with the partner accounts, each partner account associated with a partner of the device manufacture; and
transmitting the first encryption keys and device functional data associated with wireless identifiers provided from the device manufacture only to a partner of an associated partner account.

13. A computer-implemented method, comprising:
receiving a wireless device identifier from an access device, the wireless device identifier identifying a wireless device in communication with the access device;
identifying an encryption key associated with the wireless device identifier, the identified encryption key matching an encryption key stored in the wireless device; and
transmitting the identified encryption key to the access device so that the access device can communicate with the wireless device over an encrypted communication channel that is established by use of the identified encryption key and the encryption key stored in the wireless device.

14. The method of claim 13, wherein the identified encryption key and the encryption key stored in the wireless device are matching symmetric encryption keys.

15. The method of claim 13, wherein the identified encryption key and the encryption key stored in the wireless device are a matching public key and private key.

16. The method of claim 13, wherein the wireless device identifier identifying a wireless device in wireless communication with the access device is received by the access device over an unencrypted communication.

17. The method of claim 13, wherein the wireless device communicated according to an IEEE 802.15.4 standard.

18. The method of claim 13, wherein the wireless device identifier comprises a media access control (MAC) address.

19. The system of claim 13, further comprising:
identifying device functional data associated with the identified wireless device identifier; and
transmitting the device functional data to the access device.

20. A system, comprising:
a data store storing associations of cluster data sets to wireless device identifiers, each cluster data set defining one or more wireless device functionalities of a wireless device identified by a corresponding wireless device identifier;
a repository manager comprising instructions executable by a processing system that includes one or more computers and upon such execution cause the processing system to perform operations comprising:
receiving a wireless device identifier from an access device, the wireless device identifier identifying a wireless device in communication with the access device, the access device being connected to a network and facilitating a wireless connection of the wireless device to the network;
identifying a wireless device identifier in the data store that matches the received wireless identifier;
identifying a corresponding cluster data set associated with the identified wireless device identifier; and
transmitting the corresponding cluster data a service provider that provides a service to a user of the wireless device by use of the wireless device.

21. The system of claim 20, wherein the repository manager comprises further instructions executable by the processing system and upon such execution cause the processing system to perform operations comprising:
associating write privileges for the data store with a device manufacturer account, the device manufacturer account being associated with a device manufacturer of the wireless devices;
receiving associations of wireless identifiers, first encryption keys, and cluster data from the device manufacture; and
storing the associations of wireless identifiers, first encryption keys, and cluster data in the data store according to the write privileges.

22. Software stored in a computer readable medium and comprising instructions executable by a processing system and upon such execution cause the processing system to perform operations comprising:
receiving a wireless device identifier from an access device, the wireless device identifier identifying a wireless device in wireless communication with the access device, the access device being connected to a network and facilitating a wireless connection of the wireless device to the network;
identifying an encryption key associated with the wireless device identifier, the identified encryption key matching an encryption key stored in the wireless device; and
transmitting the identified encryption key to the access device so that the access device can communicate with the wireless device over an encrypted communication channel that is established by use of the identified encryption key and the encryption key stored in the wireless device.

23. Software stored in a computer readable medium and comprising instructions executable by a processing system and upon such execution cause the processing system to perform operations comprising:
receiving a wireless device identifier from an access device, the wireless device identifier identifying a wireless device in wireless communication with the access device, the access device being connected to a network and facilitating a wireless connection of the wireless device to the network;
identifying a wireless device identifier in the data store that matches the received wireless identifier;
identifying a corresponding cluster data set associated with the identified wireless device identifier; and
transmitting the corresponding cluster data to a service provider that provides a service to a user of the wireless device by use of the wireless device.
